(19) United States
(12) Patent Application Publication
(10) Pub. No.: US 2024/0336036 A1
(43) Pub. Date: Oct. 10, 2024

(54) LAMINATED PANE FOR A VEHICLE, VEHICLE AND METHOD FOR PRODUCING A LAMINATED PANE

(71) Applicant: Webasto SE, Stockdorf (DE)

(72) Inventors: Wladislaw BRONSTEIN, Stockdorf (DE); Olivier FARREYROL, Stockdorf (DE)

(21) Appl. No.: 18/619,550

(22) Filed: Mar. 28, 2024

(30) Foreign Application Priority Data
Apr. 5, 2023 (DE) 102023108728.2

(51) Int. Cl. B32B 17/10

(52) U.S. Cl. CPC B32B 17/10036; B32B 17/10201; B32B 17/1099; B32B 2307/204; B32B 2307/4026; B32B 2307/41; B32B 2605/08

(57) ABSTRACT

In a laminated pane for a vehicle, a vehicle and a method for producing a laminated pane, the laminated pane comprises:
a first pane which has a first main surface and has a second main surface which opposes the first main surface in a stacking direction,
a second pane which has a third main surface and has a fourth main surface which opposes the third main surface in the stacking direction,
an electrically conductive coating which is arranged on the second main surface and which has a side which faces away from the first pane,
an electrically conductive printed portion which is arranged on the side, wherein the printed portion can be electrically coupled to a wiring system of the vehicle.

### CROSS-REFERENCE TO RELATED APPLICATION

This application claims the benefit of German Patent Application No. 102023108728.2, filed Apr. 5, 2023, which is incorporated herein by reference in its entirety.

### TECHNICAL FIELD

A laminated pane for a vehicle is specified. A vehicle which comprises such a laminated pane is also specified. A method is also specified for producing a laminated pane for a vehicle, in particular for producing a laminated pane described herein.

### BACKGROUND

Motor vehicles have transparent or translucent panes at various locations. A laminated glass pane for a vehicle is described in EP 3787894 A1.

### SUMMARY

It is desirable to specify a laminated pane for a vehicle which can be produced in an efficient manner. It is also desirable to specify a vehicle having such a laminated pane. It is also desirable to specify a method for producing a laminated pane for a vehicle which can be carried out in an efficient manner.

According to one embodiment, a laminated pane for a vehicle comprises:
a first pane which has a first main surface and has a second main surface which opposes the first main surface in a stacking direction,
a second pane which has a third main surface and has a fourth main surface which opposes the third main surface in the stacking direction,
an electrically conductive coating which is arranged on the second main surface and which has a side which faces away from the first pane,
an electrically conductive printed portion which is arranged on the side which faces away from the first pane, wherein the printed portion can be electrically coupled to a wiring system of the vehicle.

The electrically conductive printed portion can be arranged on the side which faces away from the first pane. Moreover, in one embodiment the electrically conductive printed portion can be part of the electrically conductive coating, wherein the electrically conductive printed portion is applied to the electrically conductive coating on the side which faces away from the first pane and is at least partially diffused into the electrically conductive coating and at least partially connected or mixed in terms of material with the electrically conductive coating. Thus in such an embodiment there is a higher concentration of the electrically conductive printed portion in the electrically conductive coating on the side which faces away from the first pane, and this reduces in the direction of the first pane. For example, the electrically conductive printed portion is applied to the electrically conductive coating on the side which faces away from the first pane, wherein the electrically conductive printed portion is connected, in particular is supplied, to the electrically conductive coating by means of thermal deposition. Preferably, the electrically conductive printed portion is partially diffused into the electrically conductive coating. Alternatively or additionally, the electrically conductive printed portion can be applied to the electrically conductive coating by etching or by a thermal reaction. One example is a combination of the electrically conductive printed portion applied to the side which opposes the first pane and the electrically conductive printed portion diffused into the electrically conductive coating.

The electrically conductive coating can comprise a plurality of sub-layers, wherein preferably each or only one or more thereof are conductive. For example, a plurality of thicknesses of silver layers can be present. In particular, in the embodiment with a plurality of layers a diffusion as described above is advantageous.

For example, the electrically conductive printed portion is arranged on the side and is connected to the electrically conductive coating during a bending process of the first and/or second pane. An electrical connection can be produced thereby.

The first, second, third and fourth main surfaces have in each case a greater extent than the side surfaces of the first and second pane oriented transversely thereto. The first pane extends extensively in a planar manner and has a significantly greater extent along the first and second main surface than transversely thereto. The second pane extends extensively in a planar manner and has a significantly greater extent along the third and fourth main surface than transversely thereto.

The electrically conductive coating serves, for example, for heating the laminated pane during operation. The electrically conductive coating thus functions during operation, for example, in the manner of an electrical resistance heater. Thus it is possible, for example, to de-ice the pane or to remove condensation. The electrically conductive coating is preferably also configured to reflect infrared radiation. Thus, in particular in the installed state, a heat input from outside the vehicle into the interior of the vehicle is reduced. The electrically conductive coating makes it possible for less infrared radiation to pass into the interior of the vehicle than if no electrically conductive coating were to be present. The electrically conductive coating comprises, for example, a material made of a transparent conductive oxide, in particular a metal oxide, and/or for example has a silver layer which is applied by vapour deposition and which has a thickness in the nanometer range and thus is translucent to the human eye. For example, the silver layer is applied by means of cathode sputtering. Further exemplary materials for an electrically conductive coating are ITO (indium tin oxide or tin-doped indium oxide) and/or aluminium and/or copper.

The electrically conductive printed portion serves for the electrical contact of the electrically conductive coating. The electrically conductive printed portion and the electrically conductive coating are electrically connected together. During operation, electrical energy from the wiring system of the vehicle can be transmitted to the electrically conductive coating in order to heat it up, for example.

The arrangement of the electrically conductive printed portion on the side of the coating facing away from the first pane makes it possible for a first pane which has already been coated to be printed. The printed portion, however, permits a visual concealment of further elements, for example a busbar which serves for the supply of electrical energy. When viewed from the outside, the electrically conductive printed portion conceals the intermediate space between the second and the third main surfaces. The electrically conductive coating is arranged primarily between the first pane and the printed portion. Since the coating is transparent to the human eye, the printed portion is visible from the outside.

According to at least one embodiment, the laminated pane has a second printed portion. The second printed portion is arranged on the second main surface. The second printed portion is arranged laterally adjacent to the electrically conductive printed portion. In particular, the second printed portion is not electrically conductive. The second printed portion is, in particular, a black printed portion which is arranged on the edge of the laminated pane. The electrically conductive printed portion is arranged laterally adjacent to the second printed portion. On the second main surface the electrically conductive printed portion is arranged further inwardly than the second printed portion. Thus the electrically conductive printed portion is spaced substantially further apart from the edge region of the second main surface than the second printed portion.

According to one exemplary embodiment, the electrically conductive printed portion is configured to be opaque, in particular black. The colour point of the electrically conductive printed portion and the colour point of the second printed portion are adapted to one another, for example, so that as far as possible they have the same colour point. In this manner, the electrically conductive printed portion and the second printed portion arranged adjacent to one another act, in particular, as a common black surface when viewed from the outside.

According to at least one embodiment, the laminated pane has a third printed portion. The third printed portion is arranged on the fourth main surface. The third printed portion is preferably arranged in a projection onto the second main surface overlapping with the electrically conductive printed portion. In particular, the third printed portion is arranged in the projection overlapping with the electrically conductive printed portion and the second printed portion. The intermediate space between the electrically conductive printed portion and the fourth main surface is thus visually covered by the electrically conductive printed portion, the second printed portion and the third printed portion, so that the further elements arranged therebetween, such as for example the busbar, cannot be identified from one side or from the other side.

According to at least one embodiment, the busbar can be electrically connected to the wiring system of the vehicle. The busbar is arranged on a contact side of the electrically conductive printed portion. The contact side is arranged on the side of the electrically conductive coating which faces away from the first pane. The busbar is electrically conductively connected to the electrically conductive printed portion. The busbar has, for example, a copper cable or a plurality of copper cables which are configured to conduct electrical energy to the electrically conductive printed portion.

According to at least one embodiment, a vehicle which has a laminated pane according to one of the embodiments described herein is specified. The laminated pane is, for example, a windshield. Alternatively or additionally, the laminated pane is a roof pane, for example. Alternatively or additionally, the laminated pane is a side pane, for example. Alternatively or additionally, the laminated pane is a rear pane, for example. The laminated pane is coupled electrically to the wiring system of the vehicle. In particular, the electrically conductive printed portion is electrically coupled to the wiring system of the vehicle in order to supply the electrically conductive coating with electrical energy.

According to at least one embodiment, a method for producing a laminated pane for a vehicle comprises the following steps:
providing a first pane which has a first main surface and has a second main surface which opposes the first main surface in a stacking direction, wherein an electrically conductive coating is arranged on the second main surface, wherein the coating has a side which faces away from the first pane,
applying an electrically conductive ink to the side,
heating the first pane together with the ink for forming an electrically conductive printed portion which is arranged on the side.

The method serves, in particular, for producing a laminated pane described herein. Advantages, features and developments which are described in connection with the laminated pane also apply to the method and vice versa.

The method permits the pane, which is already coated with the electrically conductive coating, to be printed. The coated pane is heated together with the ink in order to bake the ink and thus to form the electrically conductive printed portion. In particular, the pane is bent at the same time during this heating process in order to form a predetermined curvature of the laminated pane. The pane thus only has to be heated once in order to form the printed portion and to form the predetermined curvature.

The arrangement of the electrically conductive printed portion on the side of the electrically conductive coating facing away from the first pane or the application of the electrically conductive ink to this side simplifies the logistics for producing the laminated pane. This permits a reduction in cost. It is possible to avoid the plurality of heating steps, for example baking the ink and bending the glass, which are carried out independently of one another. Thus the pane does not have to be repeatedly heated for these method steps. It is possible to use a pane which is already coated with the electrically conductive coating as an initial product. In particular, the pane does not have to be heated before being coated with the electrically conductive coating for forming the second electrically non-conductive printed portion (black print). The coated pane can be cut to a desired size and can then be printed with the electrically conductive ink for forming the electrically conductive printed portion and the electrically non-conductive second printed portion. Then only a single heating step is required in order to cure the electrically conductive ink and the second electrically non-conductive printed portion and to bend the pane. Thus the production process is energy efficient.

### BRIEF DESCRIPTION OF DRAWINGS

Further advantages, features and developments are found in the following examples which are described in connection with the figures. Elements which are the same, similar and which have the same function can be provided with the same reference signs in all of the figures.

In the figures:

FIG. 1 shows a schematic view of a part of a vehicle according to an exemplary embodiment,

FIGS. 2 and 3 show in each case schematic views of a laminated pane according to exemplary embodiments,

FIG. 4 shows a schematic sectional view of a part of a laminated pane according to an exemplary embodiment,

FIG. 5 shows a schematic view of a detail of a laminated pane according to an exemplary embodiment, and

FIG. 6 shows a schematic view of a flow diagram of a method according to an exemplary embodiment.

### DETAILED DESCRIPTION

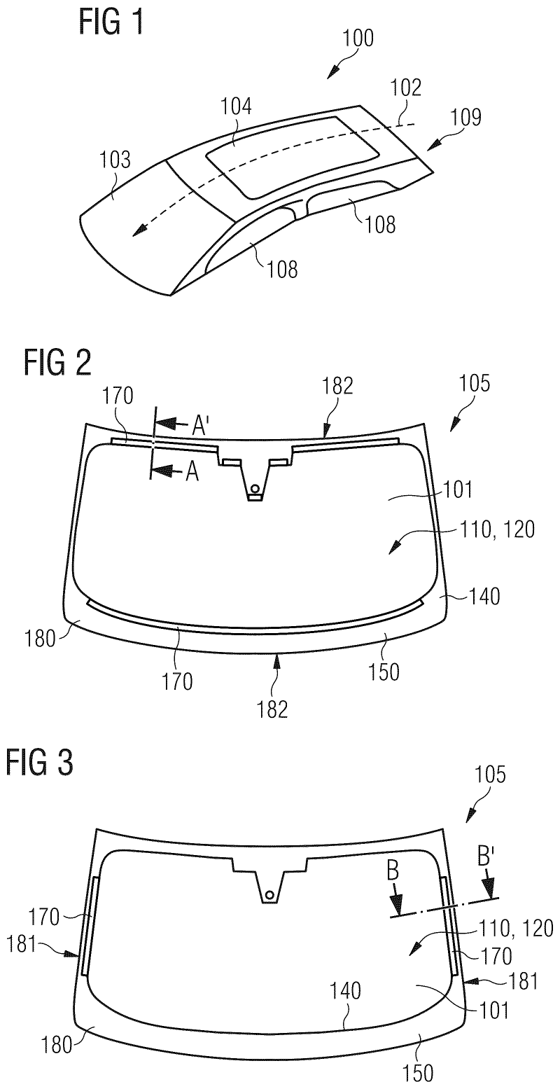

FIG. 1 shows a schematic view of a vehicle 100. The vehicle 100 is, in particular, a passenger motor vehicle. The vehicle 100 has a plurality of panes, in particular a windshield 103, a roof pane 104, side panes 108 and a rear pane 109. A vehicle longitudinal direction 102 extends from the rear pane 109 to the windshield 103.

At least one of the aforementioned panes, or a plurality or all thereof, are configured as a laminated pane 105 which is described below.

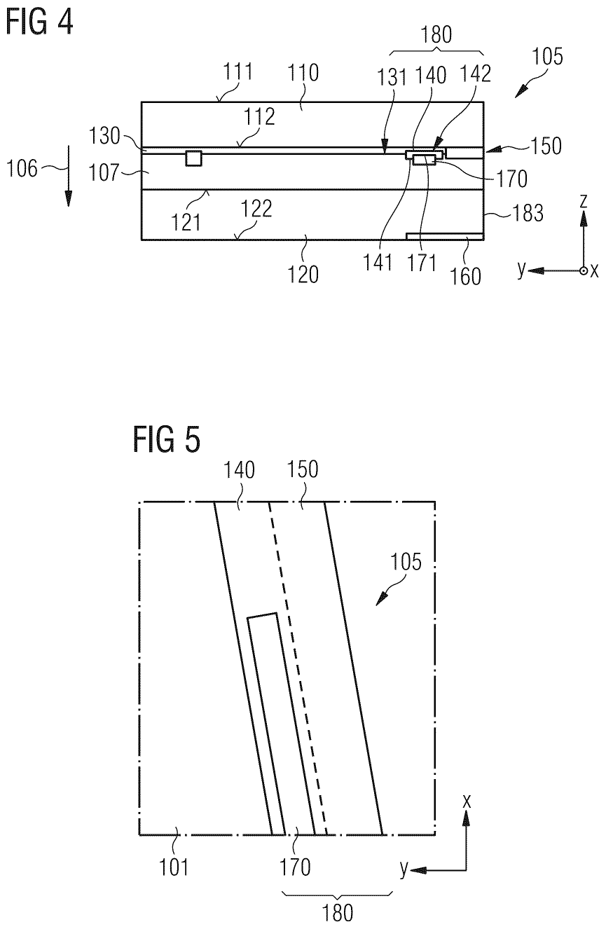

FIG. 2 shows the laminated pane 105 in an embodiment as a windshield 103. The laminated pane 105 has a clear region 101 which is configured to be transparent and/or translucent. An electrically conductive printed portion 140 is provided on the edge of the laminated pane 105. Additionally, a second printed portion 150 is provided. The two printed portions 140, 150 are configured to be opaque, in particular with a dark colour which, for example, has an effect which is as black as possible. The electrically conductive printed portion 140 visually covers a busbar 170 toward the outside. The busbar 170 is shown in FIG. 2 for improved understanding. In the ready-for-use state the busbar 170 cannot be identified from the outside but is concealed by the electrically conductive printed portion 140, as is also described in more detail below in connection with FIG. 4.

The laminated pane 105 has an electrically conductive coating 130 (FIG. 4). The busbar 170 serves for the electrical contact of the electrically conductive coating 130. For example, the busbar is arranged along two opposing longitudinal sides of the laminated pane 105, as shown in FIG. 2.

It is also possible to arrange the busbar 170 along the two transverse sides of the laminated pane 105 as shown in FIG. 3. During operation, on one side the busbar 170 is connected to the plus pole of an electrical wiring system of the vehicle 100 and the opposing busbar 170 is connected to the minus pole. Thus the electrically conductive coating 130 can be supplied with electrical energy by means of the busbar 170, in particular in order to heat the laminated pane 105. According to exemplary embodiments, the electrically conductive coating thus forms an electrical resistance heater.

FIG. 4 shows a sectional view along the line AA′ according to FIG. 2 or along the line BB′ of FIG. 3.

The laminated pane 105 initially has a first pane 110 in a stacking direction 106. The first pane 110 in the ready-for-use state faces outwardly and is arranged facing away from an interior of the vehicle 100. The first pane 110 has a first main surface 111 and a second main surface 112 arranged opposingly. The first main surface 111 faces outwardly in the ready-for-use state. The second main surface 112 faces an interior of the vehicle 100 in the ready-for-use state. In particular, the second main surface 112 is arranged opposite the first main surface 111 in the stacking direction 106.

The laminated pane 105 has a second pane 120. The second pane has a third main surface 121 and a fourth main surface 122. The third main surface 121 is faces the first pane 110. The fourth main surface 122 is arranged opposite the third main surface 121 in the stacking direction 106. The second pane 120 in the ready-for-use state faces an interior of the vehicle 100. The four main surfaces 111, 112, 121, 122 are aligned and spaced apart from one another. The four main surfaces 111, 112, 121, 122 are arranged parallel to one another, in particular in terms of conventional tolerances.

The first pane 110 and the second pane 120 are, in particular, clear glass panes.

The first pane 110 and the second pane 120 are connected together by means of a plastics layer 107. The plastics layer 107 is, for example, a polyvinyl butyral (PVB) layer. The plastics layer 107 serves as a hot-melt adhesive layer in order to connect together the first pane 110 and the second pane 120 and to form the laminated pane 105. The first pane 110, which can also be denoted as the outer pane, is arranged first in the stacking direction 106, followed by the plastics layer 107 and followed in turn by the second pane 120 which can also be denoted as the inner pane.

The electrically conductive coating 130 is arranged on the second main surface 112. The electrically conductive coating 130 is, in particular, a thin silver coating applied by vapour deposition. Firstly, the electrically conductive coating 130 serves for not allowing heat radiation in the infrared range to pass from the outside into the interior of the vehicle 100 and for reflecting this heat radiation outwardly. This reduces an input of heat into the interior of the vehicle 100 due to solar radiation, for example in the summer. Secondly, the electrically conductive coating 130 fulfils a heating function in order to heat the laminated pane 105. When an electrical voltage is applied, the electrically conductive coating 130 can be heated in order to heat the first pane 110 and/or the second pane 120.

The electrically conductive coating 130 is applied directly to the second main surface 112. The second printed portion 150 is applied to the second main surface 112 laterally in the Y-direction adjacent to the electrically conductive coating 130. The second printed portion 150 is thus arranged laterally adjacent to the electrically conductive coating 130.

In the stacking direction 106, the electrically conductive printed portion 140 is applied to one side 131 of the electrically conductive coating 130. The side 131 faces away from the first pane 110. The electrically conductive coating 130 is thus arranged between the second main surface 112 and the electrically conductive printed portion 140 in the stacking direction 106. The electrically conductive printed portion 140 and the electrically conductive coating 130 are in direct contact with one another. An electrically conductive connection 142 is formed between the electrically conductive printed portion 140 and the electrically conductive coating 130.

The electrically conductive printed portion 140 is arranged laterally adjacent to the second printed portion 150 in the Y-direction. In the Y-direction from an outer face 183 in the direction of the centre of the laminated pane 105, the second printed portion 150 is provided first, followed by the electrically conductive printed portion 140. In the view according to FIG. 4, the outer face 183 runs in the Z-direction and connects the first main surface 111 to the fourth main surface 122.

In the present case, the electrically conductive printed portion 140 is arranged on the side 131 of the electrically conductive coating 130 facing the second pane 120. In the stacking direction 106, the electrically conductive printed portion 140 is arranged between the electrically conductive coating 130 and the plastics layer 107. The electrically conductive printed portion 140 is at least partially in direct contact with the plastics layer 107.

In this example, even if the electrically conductive printed portion 140 is not in direct contact with the first pane 110, in one embodiment the electrically conductive printed portion 140 can be at least partially diffused into the electrically conductive coating 130, for example by thermal treatment.

In the stacking direction, the busbar 170 is arranged on a contact side 141 of the electrically conductive printed portion 140 facing away from the first pane 110. The busbar 170, in particular, is not in immediate and direct contact with the electrically conductive coating 130. The busbar 170 is arranged on the contact side of the electrically conductive printed portion 140, so that the electrically conductive printed portion 140 is arranged between the electrically conductive coating 130 and the busbar 170 in the stacking direction 106. The electrically conductive printed portion 140 and the busbar 170 are in direct contact with one another. An electrically conductive connection 171 is formed between the electrically conductive printed portion 140 and the busbar 170.

A third printed portion 160 is provided on the fourth main surface 122. The third printed portion 160 extends in the Y-direction from the outside, in particular approximately as far inwardly as the electrically conductive printed portion 140 and the second printed portion 150 together. The third printed portion 160 extends at least sufficiently far that the third printed portion 160 protrudes beyond the busbar 170 in the Y-direction.

The busbar 170, which is configured as an electrical conductor made of copper, for example, is electrically connected to the wiring system of the vehicle 100. The busbar 170 permits the supply of electrical energy to the electrically conductive coating 130 via the electrically conductive printed portion 140. Current from the busbar 170 is conducted by the electrically conductive printed portion 140 and is conducted to the electrically conductive coating 130.

The busbar 170 is visually covered by the electrically conductive printed portion 140 and the third printed portion 160, so that the busbar 170 is not visible, in particular in the Z-direction, according to FIG. 4. From the outside, the busbar 170 is covered by the electrically conductive printed portion 140. Firstly, the electrically conductive printed portion 140 is thus electrically conductive in order to ensure the electrical connection between the electrically conductive coating 130 and the busbar 170. Secondly, the electrically conductive printed portion 140 is configured to be sufficiently opaque in order to cover the busbar 170 visually. For example, the electrically conductive printed portion 140 is printed from a black-coloured silver ink. The black-coloured silver ink is thus electrically conductive due to its silver component and is sufficiently visually opaque due to its black colour in order to conceal the busbar 170. The black colour point of the electrically conductive printed portion 140 and a black colour point of the second printed portion 150 are coordinated with one another, in particular, so that they are as similar or identical as possible. Viewed from the outside, the second printed portion 150 and the electrically conductive printed portion 140 appear as uniform as possible, as also shown in FIG. 4. The electrically conductive printed portion 140 is formed, in particular, from a black ceramic ink. The second printed portion 150 is also formed, in particular, from a black ceramic ink which as far as possible is not electrically conductive but forms an ohmic resistance. The electrically conductive printed portion 140 and the second printed portion 150 are applied, for example, in separate printing processes. For example, a digital printing process, such as inkjet printing, is suitable therefor. Thus the two printed portions 140, 150 can be applied directly adjacent to one another without overlapping in the Y-direction and with as little spacing as possible in the Y-direction.

As shown in FIG. 5 a black edge which is composed of the electrically conductive printed portion 140 and the second printed portion 150 is configured on an edge 180 of the laminated pane 105 adjacent to the clear region 101, when the first main surface 111 of the first pane 110 is viewed in the direction of the second pane 120 in the stacking direction 106. In FIG. 5, the busbar 170 is shown for improved understanding but is not visible under real conditions, since it is covered by the electrically conductive printed portion 140. The two printed portions 140, 150 are arranged adjacent to one another in the Y-direction, wherein a boundary between the two printed portions 140, 150 can be identified in FIG. 5 by a dashed line but is not visible in a real laminated pane 105. The electrically conductive coating 130, which is configured to be transparent, is also not identifiable or at least only barely identifiable in the region of the electrically conductive printed portion 140 when the first main surface 111 is viewed from the outside. The electrically conductive printed portion 140 appears black in order to cover the busbar 170 and to act as uniform edge together with the second printed portion 150.

The electrically conductive coating 130 does not extend fully to the edge of the laminated pane 105 in the Y-direction. No electrically conductive coating 130 is provided in the region of the second printed portion 150. For example, this region is already left free when the electrically conductive coating 130 is coated. It is also possible that the electrically conductive coating 130 initially extends over the entire surface area of the second main surface 112. An ink, which removes, for example etches or dissolves, the electrically conductive coating 130 from the second printed portion 150 after the ink has been printed, is then used for the second printed portion 150. Thus the electrically conductive coating 130 is protected by the second printed portion 150 from external influences. Thus, for example, it is possible to avoid corrosion on the electrically conductive coating 130.

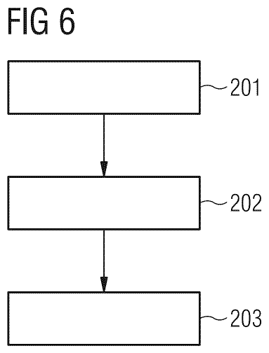

FIG. 6 shows a flow diagram of a method for producing a laminated pane 105. In a step 201, the first pane 110 is provided with the electrically conductive coating 130. In this state, the first pane 110, in particular, does not yet have the printed portion on the first main surface 111 which serves for visually covering the busbar 170. The coating 130 is in contact with the entire surface area of the first main surface 111. The electrically conductive coating 130 is applied to a pane 110 which is unprinted in the edge region.

Then in a step 202 the electrically conductive printed portion 140 is formed. To this end, an electrically conductive ink is applied to the electrically conductive coating 130. The ink for forming the second printed portion 150 is applied to the second main surface 112 laterally adjacent thereto. In the Z-direction according to FIG. 4, the two inks for the printed portion 140 and the printed portion 150 are thus arranged offset to one another in different planes. The electrically conductive ink for the printed portion 140 is arranged on the electrically conductive coating 130 and the ink for the second printed portion 150 is arranged on the second main surface 112 of the first pane 110. The ink for the second printed portion 150 can also be a caustic ink which is arranged on the side 131 of the electrically conductive coating 130 facing away from the first pane 110.

Then in a step 203 the pane 110 is heated together with the applied ink. For example, heating is carried out up to a temperature of approximately 600° C. As a result, the ceramic inks are baked and the printed portions 140 and 150 are formed. According to exemplary embodiments, at the same time a desired curvature of the pane 110 is also formed. Thus, by means of single heating step, both the ceramic ink is baked and a curvature of the glass pane 110 is achieved. The curvature and the baking of the ink do not have to take place in separate heating steps. Thus the method for producing the laminated pane 105 can be carried out in a manner which is energy-efficient and thus cost-efficient.

Then the busbar 170 is applied to the electrically conductive printed portion 140, the plastics layer 107 and the second pane 120 are arranged with the printed portion 160 and the laminated pane 105 is formed in a lamination step by melting the plastics layer 107.

Before it is coated with the electrically conductive coating 130, the first pane 110 does not have to be heated in order to bake an ink. This takes place only after the electrically conductive coating 130 has been applied to the first pane 110. Thus it is possible to print the coated pane 110 and to process it further to form the laminated pane 105 without complex logistics. This also ensures a reliable visual covering of the busbar 170 which leads to a desired aesthetic appearance of the laminated pane 105. During operation, the electrically conductive coating 130 is able to be reliably supplied with electrical energy by means of the electrically conductive printed portion 140 in order to heat the laminated pane 105, for example, as desired.

### REFERENCE SIGNS

100 Vehicle
101 Clear region
102 Vehicle longitudinal direction
103 Windshield
104 Roof pane
105 Laminated pane
106 Stacking direction
107 Plastics layer
108 Side pane
109 Rear pane
110 First pane
111 First main surface
112 Second main surface
120 Second pane
121 Third main surface
122 Fourth main surface
130 Electrically conductive coating
131 Side
140 Electrically conductive printed portion
141 Contact side
142 Electrically conductive connection
150 Second printed portion
160 Third printed portion
170 Busbar
171 Electrically conductive connection
180 Edge
181 Transverse side
182 Longitudinal side
183 Outer face
201-203 Method steps
x Longitudinal direction
Y Transverse direction
Z Vertical direction

1. Laminated pane for a vehicle, comprising:
a first pane which has a first main surface and has a second main surface which opposes the first main surface in a stacking direction,
a second pane which has a third main surface and has a fourth main surface which opposes the third main surface in the stacking direction,
an electrically conductive coating which is arranged on the second main surface and which has a side which faces away from the first pane, an
an electrically conductive printed portion which is arranged on the side, wherein the printed portion can be electrically coupled to a wiring system of the vehicle.

2. Laminated pane according to claim 1, comprising a second printed portion which is arranged on the second main surface, wherein the second printed portion is arranged laterally adjacent to the electrically conductive printed portion.

3. Laminated pane according to claim 1, comprising a third printed portion which is arranged on the fourth main surface, wherein the third printed portion is arranged in a projection onto the second main surface overlapping with the electrically conductive printed portion.

4. Laminated pane according to claim 1, wherein the electrically conductive printed portion is configured to be opaque, in particular black.

5. Laminated pane according to claim 1, comprising a busbar which can be electrically connected to the wiring system of the vehicle and which is arranged on a contact side of the electrically conductive printed portion facing away from the side and which is electrically conductively connected to the electrically conductive printed portion.

6. Vehicle comprising a laminated pane according to claim 1, wherein the electrically conductive printed portion is electrically coupled to a wiring system of the vehicle in order to supply the electrically conductive coating with electrical energy.

7. Method for producing a laminated pane for a vehicle, comprising:
providing a first pane which has a first main surface and has a second main surface which opposes the first main surface in a stacking direction, wherein an electrically conductive coating is arranged on the second main surface, wherein the coating has a side which faces away from the first pane,
applying an electrically conductive ink to the side, and
heating the first pane together with the ink for forming an electrically conductive printed portion which is arranged on the side.

8. Method according to claim 7, comprising:
bending the first pane during the heating process to form a predetermined curvature of the first pane.

9. Method according to claim 7 comprising prior to the heating process:
applying a second printed portion to the second main surface, wherein the second printed portion is arranged laterally adjacent to the electrically conductive printed portion.

10. Method according to claim 7, comprising:
applying a busbar, which can be electrically connected to the wiring system of the vehicle, to a contact side of the electrically conductive printed portion facing away from the side, and at the same time
forming an electrically conductive connection between the busbar and the electrically conductive printed portion.

11. Vehicle according to claim 6, wherein the laminated pane is configured as at least one of the following: a windshield, a roof pane, a side pane and a rear pane.
